(19) United States
(12) Patent Application Publication
(10) Pub. No.: US 2006/0158869 A1
(43) Pub. Date: Jul. 20, 2006

(54) Led light for headgear

(76) Inventor: Matti Lahtinen, Suomusjarvi (FI)

Correspondence Address: BIRCH STEWART KOLASCH & BIRCH, PO BOX 747, FALLS CHURCH, VA, 22040-0747, US

(21) Appl. No.: 10/563,911

(22) PCT Filed: Jul. 12, 2004
(86) PCT No.: PCT/FI04/00446

§ 371 Date: Jan. 10, 2006

(30) Foreign Application Priority Data
Jul. 11, 2003 (FI) 20031059

(51) Int. Cl. F21V 21/08

(52) U.S. Cl. 362/103

(57) ABSTRACT

A LED illuminator or an equivalent illuminator with a semiconductor light source for a headgear or equivalent, said illuminator comprising one or more light emitting semiconductor light sources (4), especially LEDs (Light Emitting Diode), a frame (1, 2, 11, 12), an electronics control part (5) for controlling the semiconductor light sources, and fastening parts for fastening the illuminator, wherein the semiconductor light sources are directed in at least one given direction, such as towards a working object and/or area, said illuminator being a unitary illuminator module, wherein the semiconductor light sources are fitted in a common, preferably rectangular connection part (3), side by side and directed towards the working object and/or area, and the frame consists of two frame parts (1, 2, 11, 12) folded one over the other, which can be attached to the headgear by means of releasable quick coupling parts, preferably snap-on bayonet catches.

The present invention relates to LED illuminator designed to be attached to a headgear or equivalent and comprising one or more light emitting semiconductor light sources, especially LEDs (Light Emitting Diode), a frame, an electronics control part for controlling the semiconductor light sources, and a fixing part for fixing the illuminator.

For example in orienteering, when orienteering is done in darkness, forehead-lamps consisting of an incandescent illuminator and a power source attached to a forehead band are used. The forehead-lamp has a good illuminating efficiency, and its placement on the forehead band allows the person to move freely in the terrain and read the map without the person having to carry any hand-held illuminator in his/her hands.

The biggest drawback of present forehead-lamps is the large size of the incandescent illuminators and the high power consumption of the incandescent lamp. This also requires a large power source. In addition, due to the large size of the incandescent illuminators, present forehead-lamps are relatively ugly in appearance.

For example, specification U.S. Pat. No. 6,659,618 discloses an illuminator attached to a cap and using a light source consisting of a number of separate LEDs placed side by side. The LED has a very low power consumption and also a very small size, so it can be used to form illuminators of a relatively small size.

A drawback with the solution disclosed in the aforesaid US specification is that it is difficult to fit the illuminator inside the visor of the cap, and, as it consists of several separate LED units, it also requires a relatively large space.

The object of the present invention is to overcome the drawbacks of prior art and to create a compact LED illuminator module for a headgear or equivalent that can be easily fixed and allows the illuminator to be very effectively precision-aimed at a desired target.

The details of the features of the solution of the invention are presented in the attached claims.

By using the invention, it is possible to produce precision-directed LED illuminator modules integrated with a headgear, which are applicable for personal use e.g. in caps, surgeon's headgear, helmets, such as protective helmets, and in diving masks.

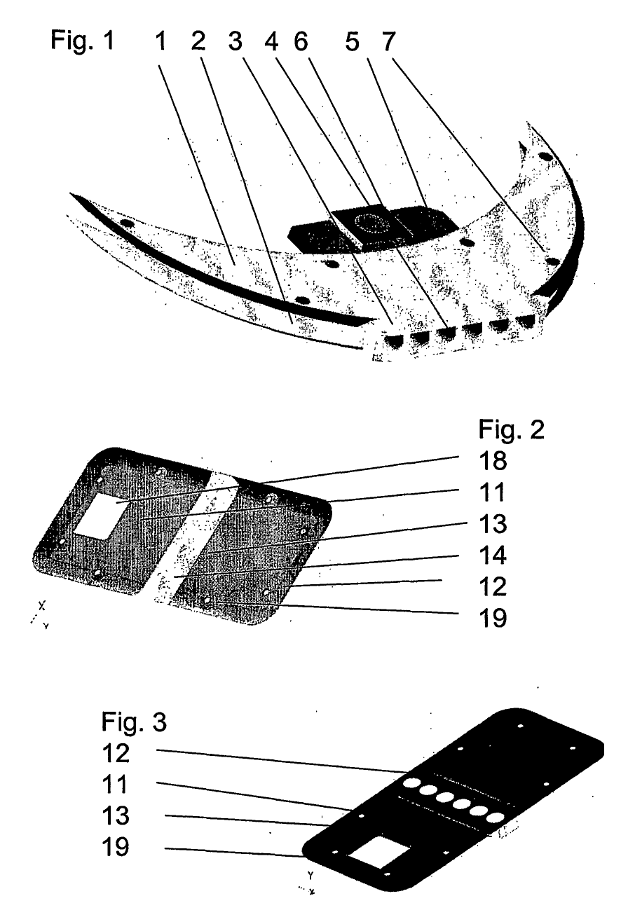

It is also possible to use different and differently colored light modules, which work together or separately. They may be fixed or movable. They are precision positioned/precision directed in a given direction. The aim is to illuminate the target and to make both hands free for only the intended action, such as e.g. a LED illuminator attached to a cap according to the personal “Led It See” illuminator system as illustrated in FIG. 1. It can also be attached to a helmet or diving mask etc.

In the following, the invention will be described in detail with reference to an example and the attached drawing, wherein

FIG. 1 presents a LED illuminator attached to a cap or equivalent, and

FIGS. 2 and 3 present another LED illuminator according to the invention in an opened position as seen from above and from below.

FIG. 1 presents a LED illuminator module according to the invention, designed to be attached to a headgear and comprising a frame 1, 2, a rectangular LED unit 3, which for example in FIG. 1 consists of six LEDs 4 placed side by side, and an electronics part 5, which is provided with a switch 6 for switching the illuminator on/off. A battery or the like for the supply of electric power to the illuminator can be mounted separately and is not shown in FIG. 1.

The frame 1, 2 consists of two curved visor-shaped frame parts 1, 2 placed one over the other, which can be folded against each other so that the visor remains between them, and they can be fastened to the visor and to each other by means of push-on snap-on fasteners 7, so the illuminator can be easily attached to the visor and detached from it when necessary. The visor can then be additionally coated e.g. with fabric. The electronics part 5 is connected to the back part of the frame part 1, 2, so it will not be a hindrance to the aiming of the LEDs.

In a corresponding manner, it is possible to implement a LED illuminator (FIGS. 2-3) designed to be attached to the visor of a helmet and comprising a LED unit 13 with LEDs and rectangular frame parts 11, 12, which can be folded together in a corresponding manner and fastened by means of snap-on fasteners. The frame part can be provided with an opening 18 for the electronics part and with holes 19 for the fasteners.

The LED control electronics consist of a resistor controlling each LED, a switch and a direct-current source. The luminous efficiency of the illuminator can be varied by varying the number and luminous efficiency of the parallel LEDs.

It is obvious to the person skilled in the art that different embodiments of the invention are not limited to the example described above, but that they may be varied within the scope of the claims presented below. It may also be a water-tight (IP class 55 and upwards) encapsulated LED unit designed to be attached to protective helmets (motor vehicle drivers' helmets, miners' helmets, professional divers' helmets). The module can also be provided with UV LEDs for use by authorities (for determining the authenticity of personal documents etc. on a road, in situ). Likewise, IR LEDs can be used for special functions. The structure of the precision-directed LED unit is the same in all applications. Vertical as well as azimuth alignment is done manually.

1. A LED illuminator or an equivalent illuminator with a semiconductor light source for a headgear or equivalent, said illuminator comprising one or more light emitting semiconductor light sources (4), especially LEDs (Light Emitting Diode), a frame (1, 2, 11, 12), an electronics control part (5) for controlling the semiconductor light sources, and fastening parts for fastening the illuminator, wherein the semiconductor light sources are directed in at least one given direction, such as towards a working object and/or area,
characterized in that
the illuminator is a unitary illuminator module, wherein
the semiconductor light sources are fitted in a common, preferably rectangular connection part (3), side by side and directed towards the working object and/or area, and
the frame consists of two frame parts (1, 2, 11, 12) folded one over the other, which can be attached to the headgear by means of releasable quick coupling parts, preferably snap-on bayonet catches.

2. A LED illuminator according to claim 1, characterized in that the module is also provided with UV LEDs so that at least some of the LEDs are UV LEDs, especially for use by authorities.

3. A LED illuminator according to claim 1, characterized in that the module is also provided with IR LEDs so that at least some of the LEDs are IR LEDs.

4. A LED illuminator according to claim 1, characterized in that it comprises a switch (6) placed in conjunction with the frame.

5. A LED illuminator according to claim 1, characterized in that it is a water-tight (IP class 55 and upwards) encapsulated LED unit designed to be attached to protective helmets (motor vehicle drivers' helmets, miners' helmets, professional divers' helmets).

6. A LED illuminator according to claim 1, characterized in that it comprises different and differently colored semiconductor light sources, which work together or separately.

7. A LED illuminator according to claim 1, characterized in that the frame parts (1, 2) can be folded against each other so that the visor or equivalent or a part of it remains between them.
